(19) United States
(12) Patent Application Publication
(10) Pub. No.: US 2025/0094889 A1
(43) Pub. Date: Mar. 20, 2025

(54) INTELLIGENT INTERACTIVE DECISION-MAKING METHOD FOR DISCRETE MANUFACTURING SYSTEM

(71) Applicant: NANJING UNIVERSITY OF POSTS AND TELECOMMUNICATIONS, Jiangsu (CN)

(72) Inventors: Haigen YANG, Jiangsu (CN); Donghuang LIN, Jiangsu (CN); Mei WANG, Anhui (CN); Luyang LI, Anhui (CN); Cong WANG, Jiangsu (CN); Jixin LIU, Jiangsu (CN); Fanyu ZENG, Jiangsu (CN); Yan GE, Jiangsu (CN)

(73) Assignee: NANJING UNIVERSITY OF POSTS AND TELECOMMUNICATIONS, Jiangsu (CN)

(21) Appl. No.: 18/290,808

(22) PCT Filed: Apr. 4, 2023
(86) PCT No.: PCT/CN2023/086103

§ 371 Date: Jan. 22, 2024

(30) Foreign Application Priority Data
Nov. 30, 2022 (CN) 202211518004.X

(51) Int. Cl. G06Q 10/0631; G06N 3/092; G06Q 50/04

(52) U.S. Cl. CPC G06Q 10/06311; G06N 3/092; G06Q 50/04

(57) ABSTRACT

Disclosed is an intelligent interactive decision-making method for a discrete manufacturing system. The method includes the following steps: step 1, establishing a production scheduling optimization model and strategy for discrete manufacturing for an actual application scene; step 2, training the scheduling strategy with existing production data on the basis of a deep reinforcement learning algorithm, and storing a state having a high reward in a training process in a memory; step 3, updating the state according to prior knowledge in the memory; step 4, inputting the updated state into a deep reinforcement learning network, obtaining a corresponding reward, and updating the memory according to the reward; and step 5, repeating step 4 until model parameters converge, and saving and putting the model into an actual production scene.

### BACKGROUND

### Technical Field

The present disclosure relates to the technical field of computer data science, and particularly relates to an intelligent interactive decision-making method for a discrete manufacturing system.

### Description of Related Art

Development of national economy has promoted China's discrete manufacturing industry to a new industrialization road. Nowadays, the discrete manufacturing industry multiple in variety, small in batch and short in delivery time has a long and complex production flow and a flexible and changeable production mode. Its production process is easily disturbed by dynamic events. This problem is a challenge to intelligent decision-making and quick response ability of manufacturing enterprises. Therefore, how to rapidly allocate production resources through intelligent decision-making and further improve production ability is a research hotspot in the field of discrete manufacturing. Its implementation method has very important practical significance and application value.

Existing intelligent decision-making methods are mostly based on assumption of static production environments. That is, information of a manufacturing workshop is completely known and not intended to change. However, dynamic factors exist in an existing discrete manufacturing process, such as operator flow, order insertion and return, and device failure. They will disturb an existing production scheduling solution, make a production state into chaos, and reduce production efficiency. Therefore, an intelligent decision-making method capable of dynamically scheduling a production process has very important practical significance.

At present, a production scheduling decision-making method based on a genetic algorithm has been widely used. The algorithm is a meta-heuristic algorithm that simulates Darwin's evolution process, which can be applied to solving various production problems. Through it, high-quality solutions can be obtained. However, this type of algorithm has a huge amount of computation, which will increase exponentially along with a problem scale. A training speed of the model is too low. In addition, it is only suitable for small and medium-sized dynamic scheduling problems, but cannot solve large-scale dynamic scheduling problems. Its practical application value is low.

### SUMMARY

In order to solve technical problems, the present disclosure provides an intelligent interactive decision-making method for a discrete manufacturing system, which reduces a computation amount of model training with a memory mechanism, improves a speed of model training, and can obtain an optimal solution faster through iteration.

In order to solve the above technical problems, the present disclosure provides an intelligent interactive decision-making method for a discrete manufacturing system. The method includes the following steps:
step 1, establishing a production scheduling optimization model and strategy for discrete manufacturing for an actual application scene;
step 2, training the scheduling strategy with existing production data on the basis of a deep reinforcement learning algorithm, and storing a state having a high reward in a training process in a memory;
step 3, updating the state according to prior knowledge in the memory;
step 4, inputting the updated state into a deep reinforcement learning network, obtaining a corresponding reward, and updating the memory according to the reward; and
step 5, repeating step 4 until model parameters converge, and saving and putting the model into an actual production scene.

Preferably, in step 1. the establishing a production scheduling optimization model and strategy for discrete manufacturing for an actual application scene specifically includes: transforming a discrete manufacturing production problem into a sequential decision-making problem according to an actual scheduling goal, defining a state, an action, a reward, exploration and a use strategy according to the goal, and determining a maximum product value in a production cycle as the goal, where the reward is a total value of products in a production cycle; the state includes manufacturing information such as a general type of products to be produced in a workshop, a production batch and a processing stage of each type of products, and processing time and a processing sequence of each product, machine and device state information such as processing devices allocated for products, a device load rate, and normal or faulty devices, and environmental states such as a temperature and a humidity of the workshop; and the action is to adjust the production scheduling strategy including a product processing sequence and allocated processing devices; and then selecting a suitable deep reinforcement learning algorithm framework according to the actual application scene, and establishing the production scheduling optimization model for discrete manufacturing.

Preferably, in step 2, the training the scheduling strategy with existing production data on the basis of a deep reinforcement learning algorithm, and storing a state having a high reward in a training process in a memory specifically includes: collecting production data of a certain production cycle from a discrete manufacturing workshop put into production as a pre-training sample, selecting the deep reinforcement learning algorithm, and training a production scheduling optimization model R for discrete manufacturing with the collected production data, where the production data sampled in a current workshop is input into the model, and the model outputs a decision-making solution for scheduling optimization of a workshop production line; and
defining a memory D having capacity of M and configured to store a state-reward pair (s,r), where an action strategy formula used by a workshop state s to obtain the corresponding reward r is as follows:

$$a = \{ \begin{matrix}{arg min}_{{a}_{t}} Q ( {s}_{t} , {a}_{t} ) , & ε \\ random , & 1 - ε\end{matrix}$$

In the formula, Q(sₜ,aₜ) denotes an action value function. sₜ represents a current manufacturing workshop state. aₜ represents action scheduling to be used by a production workshop at a current moment. In the action strategy, an action is randomly selected for the current workshop state sₜ with a probability of 1−ε, and alternatively, a q value of each action of the current state is evaluated according to the action value function Q with a probability of ε, a current optimal action a is selected, an optimal scheduling strategy a is executed for the current workshop state sₜ, the reward rₜ and a next state sₜ₊₁ are obtained, and the memory is updated.

Preferably, an updating process of the memory specifically includes:
(a) if the capacity of the memory D is not full and no sᵢ(i=1,2,3, . . . , M) similar to sₜ exists, entering a state-reward pair (sₜ,rₜ), where a similarity computation formula is as follows:

$$S i {m}_{i t} = \frac{{s}_{i} \cdot {s}_{t}}{‖ {s}_{i} ‖ ‖ {s}_{t} ‖} , {s}_{i} ∈ D$$

in the formula, Simᵢₜ represents similarity between sₜ and sᵢ, and if Simᵢₜ>δ, sᵢ is considered to be similar to sₜ, where δ denotes a threshold for determining the similarity; and
(b) if sᵢ similar to sₜ exists in the memory D, selecting the state having a higher reward for replacement, where an updating formula is as follows:

$$( {s}_{i} , {r}_{i} ) = \{ \begin{matrix}( {s}_{t} , {r}_{t} ) , {s}_{t} \sim {s}_{i} and {r}_{t} > {r}_{i} \\ ( {s}_{i} , {r}_{i} ) , {s}_{t} \sim {s}_{i} and {r}_{t} \leq {r}_{i}\end{matrix}$$

in the formula, rᵢ denotes a reward corresponding to the state sᵢ, rₜ denotes a reward corresponding to the state sₜ, and “˜” represents similar; and
finally, initialization of the memory is completed, M workshop states having a highest reward are stored in the memory, and it is indicated that the manufacturing workshop has a higher reward in the M states according to the collected actual production data, which is closer to a goal of production scheduling.

Preferably, in step 3, the updating the state according to prior knowledge in the memory specifically includes: collecting production data of production cycles different from step 1 from a discrete manufacturing workshop put into production as a training and updating sample, obtaining a high-reward state sₘ most similar to sₜ in the memory through similarity computation, obtaining a weighted sum of the state and sₜ, obtaining a new workshop state sₜ*, and using sₜ* as input of a neural network R, where a specific formula is as follows:

$${s}_{t}^{*} = α {s}_{t} + β {s}_{m}$$

In the formula, sₜ* denotes an updated new state. sₜ denotes a workshop state currently input. sₘ denotes a high-reward state most similar to sₜ from the memory. α and β denote weight parameters. A selection formula of sₘ is as follows:

$${s}_{m} = {arg max}_{{s}_{i}} ( \frac{{s}_{i} \cdot {s}_{t}}{‖ {s}_{i} ‖ ‖ {s}_{t} ‖} ) , {s}_{i} ∈ D$$

In the formula, sᵢ denotes a workshop state recorded in the memory D.

In the above process, the existing high-reward state in the memory is used as the prior knowledge, such that a new state is generated. The workshop state is more likely to have a high reward value, that is, a better production result (shorter production time, lower production cost, etc.). In this way, an iterative convergence speed of the model is improved, and training time of the production scheduling optimization model for discrete manufacturing is reduced.

Preferably, in step 4, the inputting the updated state into a deep reinforcement learning network, obtaining a corresponding reward, and updating the memory according to the reward specifically includes: inputting the updated workshop state into the production scheduling optimization model R for discrete manufacturing, further optimizing an optimal strategy output by a network R, and updating the memory according to the reward corresponding to the state. A formula for obtaining the reward is as follows:

$$a = \{ \begin{matrix}{arg min}_{{a}_{t}} Q ( {s}_{t}^{*} , {a}_{t} ) , & ε \\ random , & 1 - ε\end{matrix}$$

In the formula, Q(sₜ*, aₜ) denotes an action value function. sₜ* represents an updated manufacturing workshop state. aₜ represents a scheduling strategy used by a workshop. In the strategy, an action is randomly selected for a current state sₜ with a probability of 1−ε, and alternatively, a q value of each action of the current state is evaluated according to the network Q with a probability of ε, a current optimal action a is selected, an optimal action a is executed for the current state sₜ*, the reward rₜ* and a next state sₜ₊₁ are obtained, and the memory is updated.

Preferably, an updating process of the memory specifically includes:
(a) if sᵢ similar to sₜ* exists in the memory D, using an updating formula as follows:

$$( {s}_{i} , {r}_{i} ) = \{ \begin{matrix}( {s}_{t}^{*} , {r}_{t}^{*} ) , {s}_{t}^{*} \sim {s}_{i} and {r}_{t}^{*} > {r}_{i} \\ ( {s}_{i} , {r}_{i} ) , {s}_{t}^{*} \sim {s}_{i} and {r}_{t}^{*} \leq {r}_{i}\end{matrix}$$

(b) if no sᵢ similar to sₜ* exists in the memory D, traversing the memory D, selecting (sₘᵢₙ, rₘᵢₙ) having a lowest reward to replace a state having a higher reward. An updating formula is as follows:

$$( {s}_{min} , {r}_{min} ) = \{ \begin{matrix}( {s}_{t}^{*} , {r}_{t}^{*} ) , & {r}_{t}^{*} > {r}_{min} \\ ( {s}_{min} , {r}_{min} ) , & {r}_{t}^{*} \leq {r}_{min}\end{matrix}$$

In the formula, sᵢ denotes a state recorded in the memory D.

Preferably, in step 5, the repeating step 4 until model parameters converge, and saving and putting the model into an actual production scene specifically includes: returning to step 3, repeating step 3 and step 4, continuously optimizing the memory D, quickly updating the production scheduling optimization model R through interaction between the memory D and the model R until parameters of the model R converge, which indicates that the production scheduling optimization model R reaches an optimal decision-making model, putting the model R into the manufacturing workshop, and intelligently deciding production scheduling of the workshop according to the production scheduling optimization model.

The present disclosure has the beneficial effects as follows: the present disclosure fully uses manufacturing big data, and learns an optimal strategy step by step during interaction with an environment, such that a requirement of adaptive adjustment of a workshop production state in the current field of discrete manufacturing is satisfied, intelligent decision-making of workshop production is achieved, an optimization strategy is interactively learned and updated, real-time decision-making regulation is ensured, and smooth operation of a workshop in a multi-disturbance environment is ensured. The problems that the model is complex and very difficult in solving and only suitable for small and medium-sized production scale in traditional accurate modeling methods are solved, and the present disclosure is suitable for large-scale dynamic scheduling decision-making. The memory mechanism is added, and a direction of decision-making learning is quickly adjusted according to the prior knowledge stored in the memory, such that an optimal decision can be obtained faster through iteration, a speed of model training can be improved, training cost can be reduced, it can be ensured that the model is put into production faster and the parameters can be adjusted faster to adapt to a dynamic production environment, and practical and economic value can be achieved.

### BRIEF DESCRIPTION OF THE DRAWINGS

FIG. 1 is a schematic flow diagram of a deep reinforcement learning algorithm of the present disclosure.

FIG. 2 is a schematic flow diagram of an intelligent interactive decision-making method for a discrete manufacturing system of the present disclosure.

### DESCRIPTION OF THE EMBODIMENTS

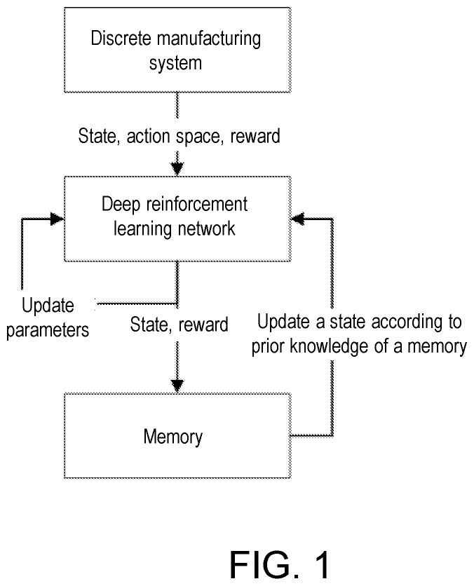

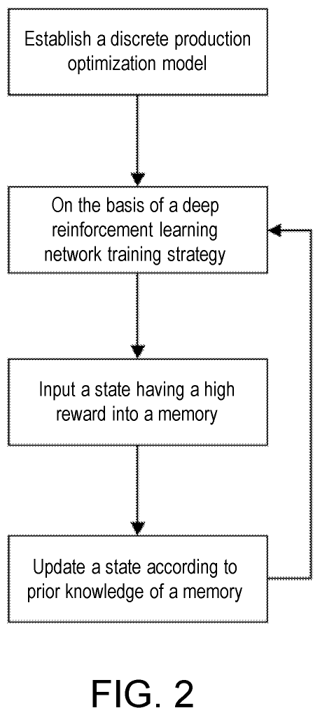

As shown in FIGS. 1 and 2, an intelligent interactive decision-making method for a discrete manufacturing system includes the following steps:
step 1, a production scheduling optimization model and strategy for discrete manufacturing are established for an actual application scene;
step 2, the scheduling strategy is trained with existing production data on the basis of a deep reinforcement learning algorithm, and a state having a high reward in a training process is stored in a memory;
step 3, the state is updated according to prior knowledge in the memory;
step 4, the updated state is input into a deep reinforcement learning network, a corresponding reward is obtained, and the memory is updated according to the reward; and
step 5, step 4 is repeated until model parameters converge, and the model is saved and put into an actual production scene.

In step 1, the production scheduling optimization model and strategy for discrete manufacturing are established for the actual application scene specifically as follows: a discrete manufacturing production problem is transformed into a sequential decision-making problem according to an actual scheduling goal, a state, an action, a reward, exploration and a use strategy are defined according to the goal, and a maximum product value in a production cycle is determined as the goal, where the reward is a total value of products in a production cycle; the state includes manufacturing information such as a general type of products to be produced in a workshop, a production batch and a processing stage of each type of products, and processing time and a processing sequence of each product, machine and device state information such as processing devices allocated for products, a device load rate, and normal or faulty devices, and environmental states such as a temperature and a humidity of the workshop; and the action is to adjust the production scheduling strategy including a product processing sequence and allocated processing devices; and then a suitable deep reinforcement learning algorithm framework is selected according to the actual application scene, and the production scheduling optimization model for discrete manufacturing is established.

In step 2, the scheduling strategy is trained with the existing production data on the basis of the deep reinforcement learning algorithm, and the state having a high reward in the training process is stored in the memory specifically as follows: production data of a certain production cycle is collected from a discrete manufacturing workshop put into production as a pre-training sample, the deep reinforcement learning algorithm is selected, and a production scheduling optimization model R for discrete manufacturing is trained with the collected production data, where the production data sampled in a current workshop is input into the model, and the model outputs a decision-making solution for scheduling optimization of a workshop production line; and
a memory D having capacity of M and configured to store a state-reward pair (s,r) is defined, where an action strategy formula used by a workshop state s to obtain the corresponding reward r is as follows:

$$a = \{ \begin{matrix}{arg min}_{{a}_{t}} Q ( {s}_{t} , {a}_{t} ) , & ε \\ random , & 1 - ε\end{matrix}$$

In the formula, Q(sₜ,aₜ) denotes an action value function. sₜ represents a current manufacturing workshop state. aₜ represents action scheduling to be used by a production workshop at a current moment. In the action strategy, an action is randomly selected for the current workshop state sₜ with a probability of 1−ε, and alternatively, a q value of each action of the current state is evaluated according to the action value function Q with a probability of ε, a current optimal action a is selected, an optimal scheduling strategy a is executed for the current workshop state sₜ, the reward rₜ and a next state sₜ₊₁ are obtained, and the memory is updated.

An updating process of the memory is specifically as follows:
(a) if the capacity of the memory D is not full and no sᵢ(i=1,2,3, . . . , M) similar to sₜ exists, a state-reward pair (sₜ,rₜ) is entered, where a similarity computation formula is as follows:

$$S i {m}_{i t} = \frac{{s}_{i} \cdot {s}_{t}}{‖ {s}_{i} ‖ ‖ {s}_{t} ‖} , {s}_{i} ∈ D$$

in the formula, Simᵢₜ represents similarity between sₜ and sᵢ, and if Simᵢₜ>δ, sᵢ is considered to be similar to sₜ, where δ denotes a threshold for determining the similarity; and
(b) if sᵢ similar to sₜ exists in the memory D, the state having a higher reward is selected for replacement, where an updating formula is as follows:

$$( {s}_{i} , {r}_{i} ) = \{ \begin{matrix}( {s}_{t} , {r}_{t} ) , {s}_{t} \sim {s}_{i} and {r}_{t} > {r}_{i} \\ ( {s}_{i} , {r}_{i} ) , {s}_{t} \sim {s}_{i} and {r}_{t} \leq {r}_{i}\end{matrix}$$

in the formula, rᵢ denotes a reward corresponding to the state sᵢ, rₜ denotes a reward corresponding to the state sₜ, and “˜” represents similar; and
finally, initialization of the memory is completed, M workshop states having a highest reward are stored in the memory, and it is indicated that the manufacturing workshop has a higher reward in the M states according to the collected actual production data, which is closer to a goal of production scheduling.

In step 3, the state is updated according to the prior knowledge in the memory specifically as follows: production data of production cycles different from step 1 is collected from a discrete manufacturing workshop put into production as a training and updating sample, a high-reward state sₘ most similar to sₜ in the memory is obtained through similarity computation, a weighted sum of the state and sₜ is obtained, a new workshop state sₜ* is obtained, and sₜ* is used as input of a neural network R. A specific formula is as follows:

$${s}_{t}^{*} = α {s}_{t} + β {s}_{m}$$

In the formula, sₜ* denotes an updated new state. sₜ denotes a workshop state currently input. sₘ denotes a high-reward state most similar to sₜ from the memory. α and β denote weight parameters. A selection formula of sₘ is as follows:

$${s}_{m} = {arg max}_{{s}_{i}} ( \frac{{s}_{i} \cdot {s}_{t}}{‖ {s}_{i} ‖ ‖ {s}_{t} ‖} ) , {s}_{i} ∈ D$$

in the formula, sᵢ denotes a workshop state recorded in the memory D.

In the above process, the existing high-reward state in the memory is used as the prior knowledge, such that a new state is generated. The workshop state is more likely to have a high reward value, that is, a better production result (higher economic benefits, lower production cost, etc.). In this way, an iterative convergence speed of the model is improved, and training time of the production scheduling optimization model for discrete manufacturing is reduced.

In step 4, the updated state is input into the deep reinforcement learning network, the corresponding reward is obtained, and the memory is updated according to the reward specifically as follows: the updated workshop state is input into the production scheduling optimization model R for discrete manufacturing, further an optimal strategy output by a network R is optimized, and the memory is updated according to the reward corresponding to the state. A formula for obtaining the reward is as follows:

$$a = \{ \begin{matrix}{arg min}_{{a}_{t}} Q ( {s}_{t}^{*} , {a}_{t} ) , & ε \\ random , & 1 - ε\end{matrix}$$

In the formula, Q(sₜ*, aₜ) denotes an action value function. sₜ* represents an updated manufacturing workshop state. aₜ represents a scheduling strategy used by a workshop. In the strategy, an action is randomly selected for a current state sₜ with a probability of 1−ε, and alternatively, a q value of each action of the current state is evaluated according to the network Q with a probability of ε, a current optimal action a is selected, an optimal action a is executed for the current state sₜ*, the reward rₜ* and a next state sₜ₊₁ are obtained, and the memory is updated.

An updating process of the memory is specifically as follows:
(a) if sᵢ similar to sₜ* exists in the memory D, an updating formula is used as follows:

$$( {s}_{i} , {r}_{i} ) = \{ \begin{matrix}( {s}_{t}^{*} , {r}_{t}^{*} ) , {s}_{t}^{*} \sim {s}_{i} and {r}_{t}^{*} > {r}_{i} \\ ( {s}_{i} , {r}_{i} ) , {s}_{t}^{*} \sim {s}_{i} and {r}_{t}^{*} \leq {r}_{i}\end{matrix}$$

(b) if no sᵢ similar to sₜ* exists in the memory D, traversing the memory, (sₘᵢₙ, rₘᵢₙ) having a lowest reward is selected to replace a state having a higher reward, where an updating formula is as follows:

$$( {s}_{min} , {r}_{min} ) = \{ \begin{matrix}( {s}_{t}^{*} , {r}_{t}^{*} ) , & {r}_{t}^{*} > {r}_{min} \\ ( {s}_{min} , {r}_{min} ) , & {r}_{t}^{*} \leq {r}_{min}\end{matrix}$$

In the formula, sᵢ denotes a state recorded in the memory D.

In step 5, step 4 is repeated until model parameters converge, and the model is saved and put into an actual production scene specifically as follows: step 3 is returned to, step 3 and step 4 are repeated, the memory D is continuously optimized, the production scheduling optimization model R is quickly updated through interaction between the memory D and the model R until parameters of the model R converge, which indicates that the production scheduling optimization model R reaches an optimal decision-making model, the model R is put into the manufacturing workshop, and production scheduling of the workshop is intelligently decided according to the production scheduling optimization model.

1. An intelligent interactive decision-making method for a discrete manufacturing system, comprising following steps:
step 1, establishing a production scheduling optimization model and strategy for discrete manufacturing for an actual application scene;
step 2, training the scheduling strategy with existing production data on a basis of a deep reinforcement learning algorithm, and storing a state having a high reward in a training process in a memory;
step 3, updating the state according to a prior knowledge in the memory;
step 4, inputting the updated state into a deep reinforcement learning network, obtaining a corresponding reward, and updating the memory according to the reward; and
step 5, repeating step 4 until model parameters converge, and saving and putting the model into an actual production scene.

2. The intelligent interactive decision-making method for the discrete manufacturing system according to claim 1, wherein in step 1, establishing the production scheduling optimization model and strategy for discrete manufacturing for the actual application scene specifically comprises: transforming a discrete manufacturing production problem into a sequential decision-making problem according to an actual scheduling goal, defining the state, an action, the reward, an exploration and a use strategy according to the goal, and determining a maximum product value in a production cycle as the goal, wherein the reward is a total value of products in the production cycle; the state comprises manufacturing information such as a general type of products to be produced in a workshop, a production batch and a processing stage of each type of products, and a processing time and a processing sequence of each product, machine and device state information such as processing devices allocated for products, a device load rate, and normal or faulty devices, and environmental states such as a temperature and a humidity of the workshop; and the action is to adjust the production scheduling strategy comprising a product processing sequence and allocated processing devices; and then selecting a deep reinforcement learning algorithm framework according to the actual application scene, and establishing the production scheduling optimization model for discrete manufacturing.

3. The intelligent interactive decision-making method for the discrete manufacturing system according to claim 1, wherein in step 2, training the scheduling strategy with existing production data on the basis of the deep reinforcement learning algorithm, and storing the state having the high reward in the training process in the memory specifically comprises: collecting production data of a certain production cycle from a discrete manufacturing workshop put into production as a pre-training sample, selecting the deep reinforcement learning algorithm, and training the production scheduling optimization model R for discrete manufacturing with the collected production data, wherein the production data sampled in a current workshop is input into the model, and the model outputs a decision-making solution for scheduling optimization of a workshop production line; and
defining the memory D having capacity of M and configured to store a state-reward pair (s,r), wherein an action strategy formula used by a workshop state s to obtain the corresponding reward r is as follows:
$$a = \{ \begin{matrix}{arg min}_{{a}_{t}} Q ( {s}_{t} , {a}_{t} ) , & ε \\ random , & 1 - ε\end{matrix}$$
in the formula, Q(sₜ,aₜ) denotes an action value function, wherein sₜ represents a current manufacturing workshop state, aₜ represents an action scheduling to be used by a production workshop at a current moment, and in the action strategy, an action is randomly selected for the current workshop state sₜ with a probability of 1−ε, and alternatively, a q value of each action of the current state is evaluated according to the action value function Q with a probability of ε, a current optimal action a is selected, an optimal scheduling strategy a is executed for the current workshop state sₜ, the reward rₜ and a next state sₜ₊₁ are obtained, and the memory is updated.

4. The intelligent interactive decision-making method for the discrete manufacturing system according to claim 3, wherein an updating process of the memory specifically comprises:
(a) if the capacity of the memory D is not full and no sᵢ(i=1,2,3, . . . , M) similar to sₜ exists, entering a state-reward pair (sₜ,rₜ), wherein a similarity computation formula is as follows:
$$Si {m}_{i t} = \frac{{s}_{i} \cdot {s}_{t}}{‖ {s}_{i} ‖ ‖ {s}_{t} ‖} , {s}_{i} ∈ D$$
in the formula, Simᵢₜ represents similarity between sₜ and sᵢ, and if Simᵢₜ>δ, sᵢ is considered to be similar to sₜ, wherein δ denotes a threshold for determining the similarity; and
(b) if sᵢ similar to sₜ exists in the memory D, selecting the state having a higher reward for replacement, wherein an updating formula is as follows:
$$( {s}_{i} , {r}_{i} ) = \{ \begin{matrix}( {s}_{t} , {r}_{t} ) , & {s}_{t} \sim {s}_{i} and {r}_{t} > {r}_{i} \\ ( {s}_{i} , {r}_{i} ) , & {s}_{t} \sim {s}_{i} and {r}_{t} \leq {r}_{i}\end{matrix}$$
in the formula, rᵢ denotes the reward corresponding to the state sᵢ, rₜ denotes the reward corresponding to the state sₜ, and “˜” represents similar; and
finally, initialization of the memory is completed, M workshop states having a highest reward are stored in the memory, and it is indicated that the manufacturing workshop has a higher reward in the M states according to the collected actual production data, which is closer to a goal of production scheduling.

5. The intelligent interactive decision-making method for the discrete manufacturing system according to claim 1, wherein in step 3, updating the state according to the prior knowledge in the memory specifically comprises: collecting the production data of production cycles different from step 1 from a discrete manufacturing workshop put into production as a training and updating sample, obtaining a high-reward state sₘ most similar to sₜ in the memory through a similarity computation, obtaining a weighted sum of the state and sₜ, obtaining a new workshop state sₜ*, and using sₜ* as input of a neural network R, wherein a specific formula is as follows:
$${s}_{t}^{*} = α {s}_{t} + β {s}_{m}$$
in the formula, sₜ* denotes an updated new state, sₜ denotes a workshop state currently input, sₘ denotes a high-reward state most similar to sₜ from the memory, and α and β denote weight parameters, wherein a selection formula of sₘ is as follows:
$${s}_{m} = {arg max}_{{s}_{i}} ( \frac{{s}_{i} \cdot {s}_{t}}{‖ {s}_{i} ‖ ‖ {s}_{t} ‖} ) , {s}_{i} ∈ D$$
in the formula, sᵢ denotes a workshop state recorded in the memory D.

6. The intelligent interactive decision-making method for the discrete manufacturing system according to claim 1, wherein in step 4, inputting the updated state into the deep reinforcement learning network, obtaining the corresponding reward, and updating the memory according to the reward specifically comprises: inputting the updated workshop state into the production scheduling optimization model R for discrete manufacturing, further optimizing an optimal strategy output by a network R, and updating the memory according to the reward corresponding to the state, wherein a formula for obtaining the reward is as follows:
$$a = \{ \begin{matrix}{arg min}_{{a}_{t}} Q ( {s}_{t}^{*} , {a}_{t} ) , & ε \\ random , & 1 - ε\end{matrix}$$
in the formula, Q(sₜ*, aₜ) denotes an action value function, wherein sₜ* represents an updated manufacturing workshop state, aₜ represents a scheduling strategy used by a workshop, and in the strategy, an action is randomly selected for a current state sₜ with a probability of 1−ε, and alternatively, a q value of each action of the current state is evaluated according to the network Q with a probability of ε, a current optimal action a is selected, an optimal action a is executed for the current state sₜ*, the reward rₜ* and a next state sₜ₊₁ are obtained, and the memory is updated.

7. The intelligent interactive decision-making method for the discrete manufacturing system according to claim 6, wherein an updating process of the memory specifically comprises:
(a) if sᵢ similar to sₜ* exists in the memory D, using an updating formula as follows:
$$( {s}_{i} , {r}_{i} ) = \{ \begin{matrix}( {s}_{t}^{*} , {r}_{t}^{*} ) , & {s}_{t}^{*} \sim {s}_{i} and {r}_{t}^{*} > {r}_{i} \\ ( {s}_{i} , {r}_{i} ) , & {s}_{t}^{*} \sim {s}_{i} and {r}_{t}^{*} \leq {r}_{i}\end{matrix}$$
(b) if no sᵢ similar to sₜ* exists in the memory D, traversing the memory, selecting (sₘᵢₙ,rₘᵢₙ) having a lowest reward to replace the state having a higher reward, wherein an updating formula is as follows:
$$( {s}_{min} , {r}_{min} ) = \{ \begin{matrix}( {s}_{t}^{*} , {r}_{t}^{*} ) , & {r}_{t}^{*} > {r}_{min} \\ ( {s}_{min} , {r}_{min} ) , & {r}_{t}^{*} \leq {r}_{min}\end{matrix}$$
in the formula, sᵢ denotes the state recorded in the memory D.

8. The intelligent interactive decision-making method for the discrete manufacturing system according to claim 1, wherein in step 5, repeating step 4 until model parameters converge, and saving and putting the model into the actual production scene specifically comprises: returning to step 3, repeating step 3 and step 4, continuously optimizing the memory D, quickly updating the production scheduling optimization model R through interaction between the memory D and the model R until parameters of the model R converge, which indicates that the production scheduling optimization model R reaches an optimal decision-making model, putting the model R into the manufacturing workshop, and intelligently deciding production scheduling of the workshop according to the production scheduling optimization model.
